(19) United States
(12) Patent Application Publication
(10) Pub. No.: US 2026/0365511 A1
(43) Pub. Date: Nov. 19, 2026

(54) METHOD FOR TREATING A PLASTIC LIQUEFACTION OIL COMPOSITION BY GASIFICATION

(71) Applicant: TotalEnergies OneTech, Courbevoie (FR)

(72) Inventors: Anne VILBÉ, Courbevoie (FR); Thomas COUSTHAM, Courbevoie (FR); Paola GAUTHIER-MARADEI, Courbevoie (FR); Hélène COULOMBEAU-LEROY, Courbevoie (FR); Michael HECQUET, Courbevoie (FR); Katell LE LANNIC, Courbevoie (FR)

(73) Assignee: TotalEnergies OneTech, Courbevoie (FR)

(21) Appl. No.: 19/137,064

(22) PCT Filed: Dec. 15, 2023
(86) PCT No.: PCT/FR2023/052019

§ 371 Date: Jun. 9, 2025

(30) Foreign Application Priority Data
Dec. 16, 2022 (FR) 2213552

(51) Int. Cl. C01B 3/34

(52) U.S. Cl. CPC C01B 3/34; C01B 2203/061; C01B 2203/062; C01B 2203/066; C01B 2203/1258

(57) ABSTRACT

Method of purifying a composition comprising a plastic liquefaction oil, comprising treating the composition to reduce the heteroatom content thereof by treatment with a basic compound followed by washing, separation, or separation followed by washing, wherein the composition thus treated is then subjected to a gasification method to produce synthesis gas comprising at least dihydrogen, carbon monoxide, and carbon dioxide.

### FIELD OF THE INVENTION

The present invention relates to a method for recovering a composition comprising a plastic liquefaction oil by gasification. The method according to the invention is used in particular to reduce the heteroatom concentration of the feedstocks coming from plastic waste, in view of the use thereof in a gasification method.

### PRIOR ART

Plastic waste is often directed towards landfill sites or incinerated, and a smaller portion is directed towards recycling. However, there is a significant need, encouraged by regulations, to limit plastic waste in landfill sites. On the other hand, the elimination of plastic waste in landfill sites is becoming increasingly difficult. Therefore, it is necessary to recycle plastic waste.

One possible route for recycling plastic is the liquefaction of plastic by pyrolysis or hydrothermal liquefaction. The resulting liquid can then be fed into a gasification method to complete the plastic recycling process. However, the plastic oil obtained generally contains large quantities of dienes and heteroatoms, including chlorine. These many heteroatoms, including chlorine, are contaminants in gasification methods. In addition, dienes react easily by forming gums and chlorine causes corrosion problems. Therefore, it is necessary to treat the plastic liquefaction oils to be able to recycle them. There are numerous treatment methods used to reduce the heteroatom content of plastic liquefaction oils.

Patent application WO 2020/020769 claims a sequence of methods for purifying a composition comprising at least 20 ppm of chlorine. Numerous recyclable liquid wastes can be treated, including plastic pyrolysis oils. The method sequence comprises heat treating the feedstock in the presence of an alkali metal hydroxide in order to obtain a reduction of at least 50% of the chlorine content in relation to the feedstock, followed by hydrotreatment in order to obtain a further reduction of at least 50% of the chlorine content.

Patent application WO2021/105326 claims a method for upgrading liquefied plastic waste comprising a step of pretreating liquefied plastic waste by contact with an aqueous medium having a pH of at least 7 at a temperature of 200 °C or more, followed by liquid-liquid separation wherein the aqueous phase is separated from the organic phase, to produce a pretreated liquefied waste plastic material. The proposed solution comprises using an NaOH solution in water. The aqueous and organic phases are separated by physical (centrifugation) or chemical (addition of separation aids, e.g. non-aqueous solvents, addition of extra quantities of the aqueous medium used for contact or of an aqueous medium having a different alkaline substance concentration) methods, or by gravity.

Most existing purification treatments are carried out at relatively high temperatures. Due to the very high contaminant contents of plastic liquefaction oils, these treatments are not economically viable. In addition, gasification methods require a feedstock with a very low content of heteroatoms, particularly chlorine, in order to operate correctly and limit the risk of corrosion.

There is therefore a need for a method for treating plastic liquefaction oils before injection into a gasification method that is less costly.

### SUMMARY OF THE INVENTION

The invention aims to provide a method for treating plastic liquefaction oil by gasification comprising a purification treatment. In particular, this purification treatment can be carried out at a relatively low temperature while maintaining a high level of heteroatom removal, particularly of chlorine. The purification treatment is also used to reduce the content in the liquefaction oil of alkali and/or alkaline-earth metals already present and/or which have been introduced during the treatment of the plastic liquefaction oil with a basic compound containing, for example, an alkali or alkaline-earth metal.

To this end, the invention relates to a method for treating a composition comprising a plastic liquefaction oil by gasification, comprising the following steps of:
a) providing a composition comprising a plastic liquefaction oil containing at least 20 ppm by mass of heteroatoms, in particular at least 20 ppm by mass of chlorine,
b) bringing the composition provided in step a) into contact with a basic compound at a temperature of at most 450 °C to obtain a first effluent containing a modified composition,
(c) subjecting the first effluent of step (b) to (c1) washing with water or a solvent immiscible with the modified composition, (c2) separation, or to the succession of steps (c2) and (c1), and obtaining a second effluent containing a purified composition having a reduced heteroatom content, and a phase containing the basic compound and heteroatoms initially contained in the modified composition,
d) optionally, the second effluent of step c) is separated by distillation into at least two separate fractions,
e) subjecting the second effluent of step c) or one of the fractions of step d), alone or in mixture with another hydrocarbon feedstock, to a gasification method to produce synthesis gas comprising at least dihydrogen, carbon monoxide and carbon dioxide.

Advantageously, prior to the treatment of step (b), said composition can be subjected to (i) a filtration, (ii) washing with water or a polar solvent immiscible with the composition, (iii) a distillation, (iv) a decantation, or (v) to a combination of two, three or four of steps (i) to (iv). Step (b) according to the invention may comprise one or more of the following features:
step (b) is carried out in the presence of 0.1 to 50% m of basic compound in relation to the total mass of the treated composition,
prior to step b) or during step b), (i) a solid basic compound, (ii) a basic compound previously solubilized in an aqueous medium, preferably water, or (iii) a basic compound previously solubilized in a solvent, preferably a polar solvent immiscible with said composition, is added to the composition of step a),
the basic compound comprises an oxide, a hydroxide, a bicarbonate, or an alcoholate of an alkali metal cation or of an alkaline-earth metal cation, or a hydroxide or a bicarbonate of a quaternary ammonium cation, alone or in a mixture, preferably the basic compound comprises an oxide, a hydroxide, a bicarbonate of an alkali metal cation or of an alkaline-earth metal cation, or a hydroxide or a bicarbonate of a quaternary ammonium cation, alone or in mixture,
the basic compound may be selected from LiOH, NaOH, CsOH, Ba(OH)₂, Na₂O, KOH, K₂O, CaO, Ca(OH)₂, MgO, Mg(OH)₂, NH₄OH, TMAOH, TEAOH, TBuOH, MeONa, EtONa and mixtures thereof, preferably the basic compound may be selected from LiOH, NaOH, CsOH, Ba(OH)₂, Na₂O, KOH, K₂O, CaO, Ca(OH)₂, MgO, Mg(OH)₂, NH₄OH, TMAOH, TEAOH, TBuOH, and mixtures thereof,
step b) is carried out at a temperature of 50 to 450 °C, preferably 50 to 350 °C, more preferably 50 to 250 °C, more preferably still 50 to 225 °C, 50 to 200 °C, 70 to 190 °C or 80 to 185 °C, or in any range defined by any two of these limits,
step b) of contact is performed for a duration of 0.1 second to 3 hours, preferably 0.1 second to 2 hours, more preferably 1 minute to 1 hour, more preferably still 1 minute to 20 minutes or 1 minute to 16 minutes.

Step (c) according to the invention may comprise one or more of the following features:
step c1) is performed in the presence of water with a neutral, basic or acid pH, or in the presence of an organic solvent immiscible with the composition, preferably in the presence of water,
step c2) is carried out by (i) centrifugation, (ii) decantation, (iii) hydrocyclone or (iv) by a combination of two or three of these steps,
step (c) comprises at least the separation step (c2) for separating the phase containing the basic compound and heteroatoms, and the purified composition, and the phase containing the basic compound and heteroatoms is returned in whole or in part to step (b),
step (c) is preceded or followed, in particular immediately preceded or followed, by a step of separating solids by (i) filtration, (ii) centrifugation, (iii) hydrocyclone or (iv) a combination of two or more of these steps,
step c) is followed by purification by passing over a solid adsorbent in order to decrease the content of at least one element out of F, Cl, Br, I, O, N, S, Se, Si, P, As, Fe, Ca, Na, K, Mg and Hg and/or water content, optionally carried out before the optional step d) of separation,
step c) is followed by a catalytic hydrotreatment, i.e. a catalytic treatment under hydrogen, in one or two stages to provide a hydrotreated purified composition, optionally carried out before the optional step d) of separation. The purified and hydrotreated composition thus obtained may also be washed with water to remove inorganic compounds such as hydrosulfide, hydrogen chloride, ammonia, before being sent to step d) or e).

The synthesis gas produced in step e) can be (i) treated in a purification unit, (ii) treated in a Fischer-Tropsch method (in particular to produce paraffins), (iii) used as fuel (energy recovery, in particular by cogeneration), and/or (iv) used in an alcohol production unit by fermentation or catalytic means. These different units are well known. In particular, purification units can be selected in a customary manner depending on the objective and the gasification method used, in particular to remove any tar present.

The previously described steps of the method according to the invention may be carried out one after another without any intermediate steps apart from the optional additional steps described.

The invention also relates to an installation, in particular suitable for carrying out the method according to the invention, comprising an optional pre-treatment section (A), a treatment section (B), at least one optional solids separation section (S1, S2), a separation section (C), an optional hydrotreatment section (HDT), an optional distillation section (D) and a gasification section (E), wherein the different sections are fluidically connected to carry out the method according to the invention.

### DEFINITIONS

Hourly Volume Velocity (HVV) is defined as the hourly volume of feedstock flow per unit of catalyst volume and is expressed here in h⁻¹.

The terms “comprising” and “comprises” as used here are synonymous with “including”, “includes” or “contains”, “containing”, and are inclusive or without limits and do not exclude additional features, elements or method steps not specified.

The specification of a numerical domain without decimals includes all whole numbers and, when suitable, fractions of the latter (for example, 1 to 5 may include 1, 2, 3, 4 and 5 when reference is made to a number of elements, and may also include 1.5, 2, 2.75 and 3.80, when reference is made to, for example, a measurement).

The specification of a decimal also comprises the decimal itself (for example, “from 1.0 to 5.0” includes 1.0 and 5.0). Any range of numerical values mentioned again here also comprises any sub-range of numerical values mentioned above.

The expressions % by weight and % by mass (also % m) have an equivalent meaning and refer to the proportion of the mass in grams of a product relative to 100 g of a composition comprising it.

Unless indicated otherwise, the measurements given in parts per million (ppm) are expressed by weight.

“Heteroatom” means any elements of an organic compound different from carbon and hydrogen.

The expression “polar solvent” within the meaning of the present patent application covers all the chemical species, alone or in a mixture, including at least one carbon-hydrogen, carbon-halogen, carbon-chalcogen or carbon-nitrogen covalent bond and having a non-zero dipole moment. It should be understood that the term “polar solvent” within the meaning of the present definition specifically excludes water.

The term “solvent” includes the aforementioned “polar solvents” and the apolar solvents, which comprise, for example, any type of linear, branched, cyclical and/or aromatic saturated or unsaturated hydrocarbon such as pentane, cyclohexane, olefins, toluene or xylene or certain other zero or almost zero dipole moment solvents such as tetrachloromethane or carbon disulfide.

The term “naphtha” refers to the general definition used in the oil and gas industry. In particular, it is a hydrocarbon derived from the distillation of crude oil and with a boiling point of between 15 and 250 °C, according to ASTM D2887. naphtha contains practically no olefins because the hydrocarbons are derived from crude oil. It is generally considered that a naphtha has a carbon number between C5 and C11, although the carbon number may in some cases reach C15. It is also generally accepted that the density of naphtha is between 0.65 and 0.77 g/mL.

“Liquefaction oil” means an oil derived from a pyrolysis method and/or from a hydrothermal liquefaction method of hydrocarbon feedstock. This hydrocarbon feedstock may comprise plastics, biomass and/or elastomers, alone or in a mixture, particularly in the form of waste. A liquefaction oil may be formed of a mixture of two or more liquefaction oils coming from the liquefaction of different hydrocarbon feedstocks.

The pyrolysis method must be understood as a thermal cracking method, typically performed at a temperature of 300 to 1,000 °C or of 400 to 700 °C, carried out in the presence or not of a catalyst and/or of a gas (rapid pyrolysis, flash pyrolysis, catalytic pyrolysis, hydropyrolysis, steam pyrolysis, etc.).

The Hydrothermal Liquefaction (HTL) method is a thermochemical conversion method using water as solvent, reactant and catalyst of reactions for breaking down a hydrocarbon feedstock, water typically being in a sub-critical or super-critical state. The hydrothermal liquefaction method is typically performed at a temperature of 250 to 500 °C and at pressures of 10 to 25-40 MPa in the presence of water.

The expression “plastic liquefaction oil” or “oil resulting from the liquefaction of plastics” or “waste plastic liquefaction oil” or “liquefaction oil resulting from the liquefaction of waste containing plastics” or “plastic oil” refers to the liquid hydrocarbon products obtained following pyrolysis or hydrothermal liquefaction of thermoplastic and/or thermosetting polymers, alone or as a mixture, and generally in the form of waste, optionally mixed with at least one other feedstock, particularly in the form of waste, such as biomass, for example, selected from lignocellulosic biomass, herbaceous biomass (biomass of plants with a non-woody stem which die at the end of the growing season) and/or aquifer biomass (plants growing in or under water, such as algae), paper and cardboard, and/or an elastomer, for example latex, which may be vulcanized, or tires.

The plastic may be of any type, particularly any type of new or used plastic, including in household (post-consumption) or industrial waste. Plastics means materials formed of polymers and optionally of auxiliary components such as plasticizers, feedstocks, dyes, catalysts, fire retardants, stabilizers, etc. For example, these polymers can be polyethylene, halogenated polyethylene (Cl, F), polypropylene, polystyrene, polybutadiene, polyisoprene, poly(ethylene terephthalate) (PET), polylactic acid (PLA), acrylonitrile-butadiene-styrene (ABS), polybutylene, polybutylene terephthalate (PBT), polyvinyl chloride (PVC), polyvinylidene chloride, a polyester, a polyamide, a polycarbonate, a polyether, an epoxy polymer, a polyacetal, a polyimide, a polyesteramide, silicone, etc. In general, any polymer or blend of polymers capable of producing hydrocarbons by liquefaction can be used.

Biomass can be defined as an organic plant or animal product, i.e. a product composed of an agricultural or forestry plant material or composed of an animal material, including vegetable or animal oils or fats. Biomass thus comprises (i) biomass produced by surplus agricultural land, not used for human or animal feed: dedicated crops, known as energy crops; (ii) biomass produced by deforestation (forest maintenance) or agricultural land cleaning; (iii) agricultural residues from crops of cereals, vines, orchards, olive trees, fruit and vegetables, agri-food residues, etc.; (iv) forest residues from forestry and wood processing; (v) agricultural residues from livestock farming (manure, slurry, litter, droppings, etc.); (vi) household organic waste (paper, cardboard, green waste, etc.); (vii) ordinary organic industrial waste (paper, cardboard, wood, rottable waste, etc.); (viii) algae biomass, i.e. biomass formed from algae, for example microalgae (algae biomass may be an algae suspension obtained by harvesting algae from, for example, a bioreactor, or an algae residue obtained by dehydration of an algae suspension) or macroalgae; (ix) grass biomass. The plastic liquefaction oil treated by the invention may come from the liquefaction of waste containing at least 1% m, optionally 1 to 50% m, 2 to 30% m or within a range defined by any two of these limits, of one or more of the aforementioned biomasses, residues and organic waste, and the remainder consisting of plastic waste, optionally in a mixture with elastomers, particularly in the form of waste.

Elastomers are linear or branched polymers transformed by vulcanization into a three-dimensional, weakly cross-linked, infusible and insoluble network. They include natural or synthetic rubbers. They may be waste of the tire type or of any other household or industrial waste containing elastomers, natural and/or synthetic rubber, in a mixture or not with other components, such as plastics, plasticizers, feedstocks, vulcanizing agents, vulcanization accelerators, additives, etc. Examples of elastomeric polymers include ethylene-propylene copolymers, ethylene-propylene-diene terpolymer (EPDM), polyisoprene (natural or synthetic), polybutadiene, styrene-butadiene copolymers, isobutene-based polymers, chlorinated or brominated isobutylene-isoprene copolymers, acrylonitrile butadiene copolymers (NBR) and polychloroprenes (CR), polyurethanes, silicone elastomers, etc. The plastic liquefaction oil treated by the invention may come from the liquefaction of waste containing at least 1% m/m, optionally 1 to 50% m, 2 to 30% m or in a range defined by any two of these limits, of one or more aforementioned elastomers, particularly in the form of waste, the remainder consisting of plastic waste, optionally in a mixture with biomasses, residues and organic waste.

The expression “MAV” (acronym for “Maleic Anhydride Value”) refers to the UOP326-82 method that is expressed in mg of maleic anhydride that reacts with 1 g of sample to be measured.

The expression “bromine number” corresponds to the amount of bromine in grams having reacted on 100 g of sample and can be measured according to the ASTM D1159-07 method.

The expression “bromine index” is the number of milligrams of bromine that react with 100 g of sample and can be measured according to the ASTM D2710 or ASTM D5776 methods.

The boiling points as mentioned here are measured at atmospheric pressure, unless specified otherwise. An initial boiling point is defined as the temperature value from which a first vapor bubble is formed. A final boiling point is the highest temperature that can be reached during distillation. At this temperature, no more vapor can be transported to a condenser. The initial and final points are determined using techniques known in the art, and a plurality of methods adapted to the range of distillation temperatures are applicable, for example NF EN 15199-1 (2020 version) or ASTM D2887 for measuring the boiling points of petroleum fractions by gas chromatography, ASTM D7169 for heavy hydrocarbons, ASTM D7500, D86 or D1160 for distillates.

The concentration of metals in the hydrocarbon matrices can be determined by any known method. Acceptable methods include X-ray fluorescence (XRF), inductively coupled plasma mass spectrometry (ICP-MS) and inductively coupled plasma atomic emission spectrometry (ICP-AES). Specialists in analytical sciences are able to identify the method most adapted to measuring each metal and in general each heteroelement according to the hydrocarbon matrix in question. The oxygen content can be measured in accordance with the standard: ASTM D5622-17/D2504-88 (2015). The nitrogen content can be measured in accordance with the standard: ASTM D4629-17. The sulfur content can be measured in accordance with the standard ISO 20846:2011. The halogen content, particularly chlorine, bromine, fluorine, can be measured in accordance with the standard: ASTM D7359-18.

“Hydrotreatment” means any method during which hydrocarbons react with dihydrogen, typically under pressure, in the presence of a catalyst or not. Hydrotreatment may thus comprise one or more reactions selected from hydrodesulfurization (HDS), hydronitrogenation (HDN), hydrodeoxygenation (HDO), hydrodemetalation (HCM), hydrocracking, hydroisomerization and hydrogenation (hydrogenation of unsaturated compounds to saturated compounds).

“Hydrotreatment catalyst” means a catalyst favoring the incorporation of hydrogen into the products. This type of catalyst is typically a metal catalyst comprising one or more metals of groups 3, 4, 5, 6, 7, 8, 9, 10, 11, 12, 13 and 14 of the periodic table.

The specific features, structures, properties, embodiments of the invention can be freely combined into one or more embodiments not specifically described here, as this may be apparent to plastic liquefaction oil treatment specialists using their general knowledge.

### DETAILED DESCRIPTION OF THE INVENTION

In the following description, the various embodiments described, and in particular the preferred embodiments of each step, can be combined depending on the desired object.

### Description of the Composition Comprising a Plastic Liquefaction Oil

The composition provided in step (a) comprises a plastic liquefaction oil. This plastic liquefaction oil may be a plastic pyrolysis oil, a plastic hydrothermal liquefaction oil, or a mixture of both.

In one preferred embodiment, the composition may only comprise a plastic liquefaction oil.

Alternatively, the composition provided in step a) may comprise at least 1% m, or even at least 2% m, of plastic liquefaction oil(s). The remainder may then be composed of at most 99% m, respectively at most 98% m, of a diluent or solvent such as a hydrocarbon and/or of one or more components listed below.

In one embodiment, the composition may comprise at least 5% m, preferably 10% m, more preferably at least 25% m, even more preferably at least 50% m, more preferably 75% m, even more preferably at least 90% m of plastic liquefaction oil. The composition may comprise at most 80% m or 90% m or 95% m or 100% m of plastic liquefaction oil. The content by mass of plastic liquefaction oil(s) of the composition may be within any range defined by two of the previously defined limits.

The composition may further comprise one or more components derived from biomass, biomass waste or elastomer waste, such as the following components: tall oil, used edible oil, animal fat, vegetable oil such as rapeseed oil, canola oil, castor oil, palm oil, soya oil, oil extracted from algae, oil extracted from fermentation of oleaginous microorganisms such as oleaginous yeasts, biomass liquefaction oil, in particular an oil from the liquefaction of biomass such as Panicum virgatum or an oil from the liquefaction of lignocellulosic or herbaceous or aquifer biomass, for example an oil from the liquefaction of wood, herbaceous plants, algae, paper and/or cardboard, an oil obtained by liquefaction of crushed used furniture, an oil from the liquefaction of elastomers, for example latex, which may have been vulcanized, or tires, as well as mixtures thereof.

The composition may further comprise a component that is a diluent miscible with plastic liquefaction oil. Preferably, this diluent has a diene index of at most 0.5 g I₂/100 g, measured according to UOP 326-17, a bromine index of at most 5 g Br₂/100 g, measured according to ASTM D1159. Preferably, the diluent is selected from a naphtha and/or a paraffinic solvent and/or a diesel or a direct distillation gas oil, containing at most 1% by weight of sulfur, preferably at most 0.1% by weight of sulfur, and/or a hydrocarbon stream having a boiling range between 50 °C and 150 °C or a boiling range between 150 °C and 250 °C or a boiling range between 200 °C and 350 °C, preferably having a bromine index of at most 5 g Br₂/100 g, and/or a diene index of at most 0.5 gI₂/100 g or any combination thereof.

The composition may have a bromine number of at most 150 g Br₂/100 g, preferably of at most 100 g Br₂/100 g, even more preferably of at most 80 g Br₂/100 g, the most preferred being of at most 50 g Br₂/100 g, as measured according to the standard ASTM D1159.

Step (a) of providing the composition may comprise:
(a1) a step of liquefying waste containing plastics and obtaining a hydrocarbon product comprising a gaseous phase, a liquid phase and a solid phase,
(a2) a step of separating the liquid phase from said product, said liquid phase forming a plastic liquefaction oil,
(a3) an optional step of mixing the plastic liquefaction oil with a diluent or a solvent.

The liquefaction step (a1) may comprise a pyrolysis step, typically performed at a temperature of 300 to 1,000 °C or of 400 to 700 °C, this pyrolysis being, for example, a rapid pyrolysis or a flash pyrolysis or a catalytic pyrolysis or a hydropyrolysis.

Alternatively or in combination, the liquefaction step (a1) may comprise a hydrothermal liquefaction step, typically performed at a temperature of 250 to 500 °C and at pressures of 10 to 25-40 MPa.

The waste treated in step (a1) can be plastic waste optionally mixed with biomass or other types of waste, as described above.

The separation step (a2) makes it possible to eliminate the gas phase, substantially C1-C4 hydrocarbons, and the solid phase (typically char) so as to recover only the liquid organic phase forming a liquefaction oil.

Plastic liquefaction oils particularly contain paraffins, i-paraffins (iso-paraffins), dienes, alkynes, olefins, naphthenes and aromatics. Plastic liquefaction oils also contain impurities containing heteroatoms, such as chlorinated, oxygenated, sulfurous, nitrogenous and/or silylated organic compounds, metals, salts, phosphorus compounds.

The composition of the plastic liquefaction oil depends on the nature of the liquefied plastic, and optionally on any other waste liquefied with the plastic, and is substantially (in particular more than 80% m, more often more than 90% m) made up of hydrocarbons with 1 to 150 carbon atoms and impurities.

A plastic liquefaction oil typically comprises 5 to 80% m of paraffins (including cyclo-paraffins), 10 to 95% m of unsaturated compounds (comprising olefins, dienes and acetylenes), 5 to 70% m of aromatics. These contents may be determined by gas chromatography.

In particular, a plastic liquefaction oil may comprise a bromine number of 10 to 130 g Br₂/100 g, as measured according to the standard ASTM D1159, and/or a maleic anhydride index (UOP326-82) of 1 to 55 mg of maleic anhydride/1 g.

In one preferred embodiment, said plastic liquefaction oil has an initial boiling point of at least 15 °C, and a final boiling point of at most 800 °C, preferably of at most 600 °C, even more preferably of at most 560 °C, more preferably of at most 450 °C, even more preferably of at most 350 °C, preferably of 250 °C (measured according to the standard NF EN 15199-1/2).

A plastic liquefaction oil typically comprises at least 20 ppm of heteroatoms, or even at least 30 ppm of heteroatoms. Its maximum heteroatom content may be 15% by mass.

A plastic liquefaction oil may particularly comprise one or more of the following heteroatom contents: 0 to 8% m of oxygen (measured according to the standard ASTM D5622), 1 to 13,000 ppm of nitrogen (measured according to the standard ASTM D4629), 2 to 10,000 ppm of sulfur (measured according to the standard ISO 20846), 1 to 10,000 ppm of metals (measured by ICP), 50 to 6,000 ppm of chlorine (measured according to the standard ASTM D7359-18), 0 to 200 ppm of bromine (measured according to the standard ASTM D7359-18), 1 to 40 ppm of fluorine (measured according to the standard ASTM D7359-18), 1 to 2,000 ppm of silicon (measured by XRF).

### Detailed Description of the Optional Step of Pre-Treating the Composition

Between step a) and b), the invention may also comprise an optional pre-treatment step, wherein said composition is subjected, particularly immediately before step b), to (i) filtration (ii) washing with water or a polar solvent immiscible with the composition, (iii) distillation, (iv) decantation, or (v) to a combination of two, three or four of steps (i) to (iv). This additional step may make it possible to reduce a portion of the impurities contained in the composition such as oxygen, nitrogen, chlorine, sulfur or other heteroatoms. In particular, reducing the amount of oxygen may make it possible to prevent the formation of solids and/or of gels during step (c1).

During the additional washing step (ii), the polar solvent volume or water/composition ratio may be 1/99 to 90/10, 10/90 to 90/10, 20/80 to 80/20, 30/70 to 70/30, 35/65 to 65/35, 35/65 to 60/40, or 40/60 to 60/40.

When water is used for the washing (ii), it may have an acid, basic or neutral pH. An acid pH may be obtained by adding one or more organic or inorganic acids. Examples of organic acids that can be used comprise citric acid (C₆H₈O₇), formic acid (CH₂O₂), and acetic acid (CH₃COOH). Examples of inorganic acids are sulfamic acid (H₃NSO₃), hydrochloric acid (HCl), nitric acid (HNO₃), sulfuric acid (H₂SO₄), and phosphoric acid (H₃PO₄). A basic pH may be obtained by adding alkali and alkaline-earth metal oxides, alkali and alkaline-earth metal hydroxides (for example NaOH, KOH, Ca(OH)₂), alkali and alkaline-earth metal bicarbonates and amines (for example triethylamine, ethylenediamine, ammonia).

When the water is used for washing, it may be provided to return all or part of the water recovered after washing in step (c1). And optionally, when step c1) is carried out with water, the water recovered at the end of the washing of step c1) can be returned in whole or in part to this washing step (ii).

The polar solvent may have a density higher or lower than the density of the composition comprising a plastic liquefaction oil.

In particular, the density of the polar solvent may be higher or lower of 3 to 50% to that of the composition.

The polar solvent is a solvent immiscible with the composition comprising a plastic liquefaction oil to be purified.

By way of example, it may be considered that the polar solvent (or that a mixture of polar solvents if applicable) is immiscible when the recovery rate thereof is higher than or equal to 0.95. This recovery rate is defined as the ratio of the volume of extract to the volume of initial solvent, this extract being a phase containing the solvent, immiscible with the composition containing a liquefaction oil, recovered after stirring and then decantation of a mixture of one part by volume of solvent with twenty-five parts by volume of the composition containing a liquefaction oil to be purified, at atmospheric pressure and at a temperature of 20 °C.

This recovery rate can in particular be determined in accordance with the following procedure:
Introduce 50 mL of composition containing a liquefaction oil into a flat-bottom flask with a volume of 100 mL, with the aid of a +/−0.5 mL precision pipette,
Introduce 2 mL of solvent into the flask, with the aid of a +/−0.1 mL precision pipette,
Introduce a magnetic stirring bar, close the flask with a polypropylene stopper,
Stir the mixture on a mechanical stirrer plate at a speed of 500 rpm for 5 min.,
At the end of the 5 minutes, stop stirring, remove the magnetic stirring bar with the aid of a magnetic rod,
Transfer the content of the flask into a graduated tube having a precision of +/−0.05 mL for a volume less than or equal to 2 mL and a precision of +/−0.1 mL for a volume greater than 2 mL. Wait for complete demixing by decantation and measure the volume of the 2 phases with the aid of graduations. It is considered that complete demixing is achieved when the volumes of the two phases no longer vary.

Acceptable immiscible polar solvents comprise (i) sulfur compounds, for example dimethylsulfoxide, (ii) nitrogen compounds, for example N,N-dimethylformamide, (iii) halogenated compounds, for example dichloromethane or chloroform, (iv) ethylene glycol, or:
glycol ethers, including in particular polyethylene glycol of chemical formula HO—(CH2-CH2-O)n-H with a weight-average molar mass of 90 to 800 g/mol, for example diethylene glycol and tetraethylene glycol, polypropylene glycol of chemical formula H[OCH(CH3)CH2]nOH with a weight-average molar mass of 130 to 800 g/mol, for example dipropylene glycol and tetrapropylene glycol,
dialkyl formamides, in which the alkyl group can comprise from 1 to 8 or from 1 to 3 carbon atoms, in particular dimethylformamide (DMF),
dialkyl sulfoxides, in which the alkyl group can comprise from 1 to 8 or from 1 to 3 carbon atoms, in particular dimethylsulfoxide (DMSO) and sulfolane,
compounds comprising a furan ring,
cyclic carbonate esters, particularly comprising 3 to 8 or 3 to 4 carbon atoms, particularly propylene carbonate and ethylene carbonate.

One or more of the aforementioned solvents can be used. However, advantageously, a single one of the aforementioned solvents can be used provided that it is immiscible with the composition containing a liquefaction oil to be purified.

Preferably, the polar solvent may be ethylene glycol or a glycol ether, in particular polyethylene glycol of chemical formula HO—(CH2-CH2-O)n-H with a mass-average molar mass of 90 to 800 g/mol or polypropylene glycol of chemical formula H[OCH(CH3)CH2]nOH with a mass-average molar mass of 130 to 800 g/mol, or a compound comprising a furan ring, or a cyclic carbonate ester, in particular propylene or ethylene carbonate, alone or in a mixture, preferably alone.

In one preferred embodiment, the polar solvent is selected from propylene carbonate, ethylene carbonate, ethylene glycol and polyethylene glycol of chemical formula HO—(CH2-CH2-O)n-H with a weight-average molar mass of 90 to 800 g/mol, alone or in a mixture, preferably alone.

### Detailed Description of Step b)

Step b) is a step of treating the composition provided in step a) in the presence of a basic compound at a temperature of at most 450 °C to obtain an effluent comprising a treated composition.

In particular, this treatment makes it possible to modify the compounds containing heteroatoms and to promote their subsequent elimination.

Step b) is carried out in the presence of a basic compound, preferably a nucleophilic basic compound.

Advantageously, the amount of basic compound used is 0.1 to 50% m, preferably at least 0.5% m, more preferably at least 1% m, in a preferred manner at least 3% m, even more preferably at least 5% m or even at least 10% m in relation to the total mass of the treated composition (composition provided by step (a)).

Advantageously, the amount of basic compound used may be 0.1 to 15% m, more preferably 0.5 to 15% m, still more preferably 1 to 15% m, particularly 3 to 15% m, or even 5 to 15% m or 10 to 15% m relative to the total mass of the treated composition (composition provided by step a)), or in any range defined by two of the preceding limits.

The basic compound may be added to the composition provided by step (a) or before step (b) or during step (b). This addition of the basic compound to the composition can optionally be followed by a mixing step before step (b) is carried out.

The basic compound can be added to the composition in solid or solubilized form in an aqueous medium, preferably water, or in a solvent, miscible or immiscible with said composition, preferably immiscible.

When the basic compound is solubilized in a solvent or in water, a person skilled in the art will then choose an amount of solvent or water sufficient to dissolve/solubilize it, preferably an amount of solvent or water as small as possible, or just sufficient to saturate the solvent or water with the basic compound.

The ratio by volume of solvent/water containing the basic compound/organic phase, i.e. the ratio by volume of the mixture (basic compound+solvent or water)/organic phase, may be from 0.1/99.9 to 80/20, from 1/99 to 80/20, from 1/99 to 70/30, from 1/99 to 65/35, from 1/99 to 60/40, from 1/99 to 50/50, or else in any range defined by any two of the aforementioned limits.

Advantageously, the basic compound added in step (b) is in solution in water or in a solvent, and the basic compound content of the water or of the solvent is from 0.1 to 50% m, preferably from 15% to 50% m, more preferably from 25% to 50% m, in a preferred manner from 40 to 50% m, even more preferably the water or the solvent is saturated with a basic compound, in particular the water or the solvent contains just enough basic compound to obtain a saturated solution.

Advantageously, the basic compound added in step b) is in solution in water. Thus, during step b), the organic phase may be brought into contact with an aqueous solution of a basic compound, preferably a basic compound comprising an alkali or alkaline-earth metal cation. A solution, particularly an aqueous solution, saturated with a basic compound may advantageously be used. In particular, step b) may be carried out without the addition of a solvent other than water or a solvent possibly already present in the composition.

A usable miscible solvent may be a polar solvent comprising an alcohol function and/or an ether function, ideally selected from C1 to C4 alcohols, preferably from methanol, ethanol, propan-1-ol, propan-2-ol, butan-1-ol, butan-2-ol, 2-methylpropan-1-ol, propylene glycol.

A usable immiscible solvent may be an immiscible polar solvent, for example those mentioned for the optional pre-treatment step.

In one embodiment, the basic compound may comprise an oxide, a hydroxide, a bicarbonate, or an alcoholate of an alkali metal cation or of an alkaline-earth metal cation, or a hydroxide or a bicarbonate of a quaternary ammonium cation, for example of a tetramethylammonium (TMA+), tetraethylammonium (TEA+), tetrapropylammonium (TPA+), tetrabutylammonium (TBA+) cation. The basic compound may preferably comprise an oxide, a hydroxide or a bicarbonate of an alkali metal cation or of an alkaline-earth metal cation, or a hydroxide or a bicarbonate of a quaternary ammonium cation. More preferably, the basic compound may comprise an aforementioned oxide or hydroxide, alone or as a mixture.

In one preferred embodiment, the basic compound may be selected from LiOH, NaOH, CsOH, Ba(OH)₂, Na₂O, KOH, K₂O, CaO, Ca(OH)₂, MgO, Mg(OH)₂, EtONa, MeONa, NH₄OH, TEAOH, TBuOH, TMAOH, and mixtures thereof or from LiOH, NaOH, CsOH, Ba(OH)₂, Na₂O, KOH, K₂O, CaO, Ca(OH)₂, MgO, Mg(OH)₂, NH₄OH, TEAOH, TBuOH, TMAOH, and mixtures thereof. A preferred basic compound may be selected from NaOH, KOH, and mixtures thereof, preferably in solution in water or in a solvent, particularly a solvent immiscible with the composition.

The solvent used to solubilize the basic compound may be water, an alcohol, for example methanol or ethanol, or any other organic solvent for solubilizing the selected basic compound, preferably water or a solvent immiscible with the composition.

In one preferred embodiment, prior to step b) or during step b), (i) a solid basic compound, (ii) a basic compound previously solubilized in an aqueous medium, preferably water, or (iii) a basic compound previously solubilized in a solvent, preferably a polar solvent immiscible with said composition, may be added to the composition of step a), the basic compound content of the water or the solvent being from 15 to 50% by mass, preferably from 25% to 50% m, in a preferred manner from 40 to 50% m. This embodiment may in particular be combined with the temperature conditions and other operating conditions described hereinafter. This embodiment may also be combined with the particularly preferred embodiment described hereinafter.

Step b) may be carried out at a temperature of at most 450 °C. In one embodiment, step b) may be carried out at a temperature of 50 to 450 °C, preferably 50 to 350 °C, more preferably 50 to 250 °C, even more preferably 50 to 225 °C, 50 to 200 °C, 70 to 190 °C or 80 to 185 °C, or in any range defined by any two of these limits.

The treatment step b) can be carried out at an absolute pressure of 0.1 to 100 bar, preferably 1 to 50 bar.

In one particularly preferred embodiment, step b) is performed for a duration of 1 minute to 3 hours, preferably 1 minute to 1 or 2 hours, more preferably 1 minute to 20 minutes, preferably 1 minute to 16 minutes, at a temperature of at most 250 °C, more preferably at most 225 °C, even more preferably at most 200 °C, 190 °C or 185 °C. In this particularly preferred embodiment, step b) may be performed at a temperature of at least 50 °C, preferably at least 90 °C, more preferably at least 150 °C. In this particularly preferred embodiment, step b) can be performed at an absolute pressure of 0.1 to 100 bar, preferably 1 to 50 bar.

In this particularly preferred embodiment, the composition provided by step a) may advantageously be brought into contact with:
0.1 to 15% m of a basic compound, advantageously comprising an alkali or alkaline-earth metal cation, and preferably in the presence of water, preferably with 0.5 to 15% m of a basic compound, more preferably with 1 to 10% m of a basic compound (mass percentages of basic compound relative to the composition), and/or
with water containing from 15 to 50% m of basic compound, preferably from 25% to 50% m, more preferably from 40 to 50% m (mass percentages of basic compound relative to water), even more preferably with water saturated with a basic compound.

A preferred strong base can be selected from LiOH, NaOH, CsOH, Ba(OH)₂, Na₂O, KOH, K₂O, CaO, Ca(OH)₂, MgO, Mg(OH)₂, TMAOH, TEAOH, TBuOH, EtONa, MeONa and mixtures thereof. A more preferred strong base may be selected from LiOH, NaOH, CsOH, Ba(OH)₂, Na₂O, KOH, K₂O, CaO, Ca(OH)₂, MgO, Mg(OH)₂, TMAOH, TEAOH, TBuOH, and mixtures thereof, and in particular from NaOH, KOH and mixtures thereof, in particular for implementing the particularly preferred embodiment.

At the end of step b), a first effluent containing a modified composition is obtained because the impurities (compounds containing heteroatoms) have been modified by the treatment in step b). The first effluent containing the modified composition obtained at the end of step b) makes it possible to subsequently obtain a purified composition comprising a reduced heteroatom content, as explained below.

### Detailed Description of the Optional Additional Step of Separating the Solids

Step c), and particularly one or more of steps (c1) and (c2), may be preceded or followed by a step of separating solids by (i) filtration, (ii) centrifugation, (iii) hydrocyclone or (iv) a combination of two or three of these steps. This step of separating solids is particularly advantageous before step (c2) because it may make it possible to facilitate the separation of phases by eliminating all or some of the solids present in the first effluent derived from step (b).

### Detailed Description of Step c)

During step c), the effluent of step b) may be subjected to (c1) washing with water or a solvent immiscible with the modified composition, (c2) separation, or to the succession of steps (c2) and (c1). This step c) makes it possible to recover a purified composition having a reduced heteroatom content and a phase (solid or liquid) containing the basic compound and heteroatoms initially contained in the modified composition. Thus, this step makes it possible to separate the impurities from the composition.

The selection of steps (c1), (c2) or (c2)+ (c1) depends particularly on the nature of the basic compound and on the purification objective sought. It may, for example, be possible to distinguish the cases (A), (B) and (C) below:
(A) the basic compound is added to the composition of step a) in the form of a solid basic compound, step c) may then comprise:
   (A1) the washing step (c1) that makes it possible to recover a phase containing the purified composition and a phase containing the basic compound, the impurities and the water or the solvent used for the washing, or
   (A2) the separation step (c2), typically a solid-liquid extraction, which makes it possible to separate a solid phase comprising the basic compound and the impurities having precipitated and a liquid phase containing the purified composition, or
(A3) the separation step (c2) described above followed by a step of washing (c1) the liquid phase containing the purified composition recovered from step (c2),
(B) the basic compound is added to the composition of step a) solubilized in a solvent miscible with the composition, step c) may then comprise the washing step (c1) that makes it possible to recover a phase containing the purified composition and a phase containing the miscible solvent, the solubilized basic compound, the impurities, and the water or the immiscible solvent used for the washing;
(C) the basic compound is added to the composition of step a) solubilized in an aqueous medium or in a solvent immiscible with the composition, step (c) may then comprise:
   (C1) the washing step (c1) that makes it possible to recover a phase containing the purified composition and a phase containing the basic compound, the impurities, the water or the solvent used for the washing and the aqueous medium or the immiscible solvent used for adding the basic compound, or
   (C2) the separation step (c2), typically liquid-liquid separation, which makes it possible to separate the phase containing the purified composition and a phase containing the water or the immiscible solvent, the basic compound and the impurities, or
   (C3) the separation step (c2) described above followed by a step of washing (c1) the phase containing the purified composition recovered from step (c2).

When step c) implements separation (c2), i.e. in cases (A2), (A3), (C2) and (C3), the phase containing the basic compound recovered at the end of separation step (c2) can advantageously be recovered and returned in whole or in part to treatment step b). This makes it possible to reduce the amounts of basic compounds to be used and to thus reduce the associated costs.

### Detailed Description of the Washing Step (c1)

The washing step (c1) is performed with water with a neutral, basic or acid pH or with a solvent immiscible with the purified composition, preferably with water. The washing step (c1) makes it possible to recover a phase containing the purified composition and a phase containing the water or the immiscible solvent used for the washing, the basic compound and the impurities. In other words, at the end of the washing step, these phases are recovered separately, for example after a liquid/liquid separation (centrifugation and/or decantation and/or other) performed at the end of the washing step.

This step (c1) makes it possible to eliminate the impurities containing heteroatoms present in the first effluent containing the modified composition exiting step (b) by solubilizing them in a solvent (water or an organic solvent).

This washing step (c1) may also make it possible to separate the basic compound of the purified composition. The washing step (c1) is thus particularly advantageous when the basic compound used during step (b) is added to the composition in solid or solubilized form in a solvent miscible with the composition to be treated, but may also be carried out when the basic compound is in solution in a solvent (water or organic solvent) immiscible with the composition to be treated.

When the basic compound used during step b) is solid or solubilized in water or a solvent immiscible with the composition, this washing step (c1) may be omitted or carried out after the separation step (c2), as explained below.

The water used during step (c1) may have an acid (pH<7), basic (pH >7) or neutral (pH=7) pH.

In one embodiment, the water used has an acid or neutral pH. In particular, the water used does not contain a basic compound and in particular does not contain a basic compound comprising an alkali or alkaline-earth metal cation.

An acid pH may be obtained by adding one or more organic or inorganic acids. Examples are cited with reference to the washing (ii) of the optional pre-treatment step. Preferably, the water can have a pH of 0.1 to 6.9.

A basic pH can be obtained by adding a basic compound, for example those mentioned above with reference to the washing (ii) of the optional pre-treatment step or those used in step b). Preferably, the water can have a pH of 7.1 to 14.

The immiscible solvent can be any organic solvent immiscible with the composition, in particular in which the impurities containing heteroatoms are soluble. A usable immiscible solvent is, for example, a polar solvent, particularly those described in the optional pre-treatment step.

Step (c1) may be performed at a temperature of 10 °C to 120 °C, preferably of 15 °C to 95 °C, more preferably of 15 °C to 80 °C, or also in any range defined by any two of these limits, advantageously without external heating. Step (c1) is typically carried out at atmospheric pressure or at a pressure close to the pressure at which step b) is carried out.

Step (c1) may be carried out on the first effluent directly derived from step b), without any intermediate step, or on the effluent containing the purified composition exiting step (c2). When it follows step (c2), the washing step (c1) then makes it possible to eliminate any residue of the basic compound and/or impurities containing heteroatoms, still present in the purified composition exiting step (c2), which makes it possible to obtain a purified composition particularly having a chlorine content lower than or equal to 30 ppm (by mass) and a sodium content lower than or equal to 2 ppm (by mass).

During step (c1), the volume ratio of solvent or water/effluent containing the purified composition can be from 1/99 to 90/10, from 20/80 to 80/20, from 30/70 to 70/30, from 35/65 to 65/35, from 35/65 to 60/40, from 40/60 to 60/40, or in any range defined by any two of the aforementioned limits.

Step (c1) may comprise, or involve, bringing the effluent derived from step b) or (c2) into contact with water or an immiscible solvent by any means known in the prior art.

For example, the effluent derived from step b) or (c2) and the solvent or the water may be introduced into vessels, reactors or mixers commonly used in the profession and the two components may be mixed. Contact may comprise vigorous stirring of the two components with a mixing device. For example, the two components may be mixed together by stirring or by shaking. Alternatively, contact can be made in a chamber in which the two components circulate in countercurrent, for example in contact columns with suitable packing in order to increase the contact between the treated composition phase and the water or an immiscible solvent. Alternatively, contact can be made in another static mixer in co-current mode or in a cavitation chamber. This contact may occur more than one time, in particular under the conditions set out above.

The washing step (c1) may be carried out continuously or in batches.

### Detailed Description of the Separation Step (c2)

The separation step (c2) also makes it possible to separate the purified composition to obtain a phase containing the purified composition having a reduced heteroatom content, and a phase containing the basic compound and the impurities. It may be liquid/liquid separation or solid/liquid separation. Advantageously, it may be carried out by (i) centrifugation, (ii) decantation, (iii) hydrocyclone or (iv) by a combination of two or three of these steps.

Step (c2) may be carried out directly on the effluent containing the modified composition of step (b). In this case, it enables the purified composition to be separated from the basic compound, in particular when the latter has been added in solid form or in a solvent immiscible with the composition (water or immiscible organic solvent). Step (c2) then separates a phase containing the purified composition and a phase containing the basic compound and the impurities, and, if applicable, the water or the solvent immiscible with the composition. This phase containing the basic compound can then be returned to step (b) in order to reuse the basic compound. This makes it possible to reduce the amount of total basic compound consumed in step (b).

Prior to step (c2), the effluent containing the modified composition exiting step (b) may be treated in at least one mechanical or electrostatic coalescer in order to break any emulsion and to concentrate the basic compound in the solvent or the water.

Step (c2) may be performed at a temperature of 10 °C to 120 °C, preferably of 15 °C to 95 °C, more preferably of 15 °C to 80 °C, or also in any range defined by any two of these limits, advantageously without external heating. Step (c2) is typically carried out at atmospheric pressure or at a pressure close to the pressure at which step (b) is carried out.

### Detailed Description of the Optional Catalytic Hydrotreatment Step (d)

Upstream of gasification step e), advantageously upstream of the optional step d) of distillation, preferably downstream of the optional step of solids separation when present, the effluent containing the purified composition may be subjected to one-step or two-step hydrotreatment.

When this hydrotreatment is performed in a single step, the effluent is hydrotreated at a temperature of 200 to 450 °C, preferably of 200 to 380 °C in the presence of hydrogen with an absolute pressure of 20 to 140 bar, preferably of 30 to 100 bar and in the presence of a hydrotreatment catalyst, for example a catalyst of the NiMo (0.1-60% by mass) and/or CoMo (0.1-60% by mass) type generally on a support.

Alternatively, hydrotreatment can be carried out in a first step (1) in which the effluent is hydrotreated, preferably selectively hydrogenated, at a temperature of 80 to 250 °C, preferably 130 to 250 °C, in the presence of hydrogen at an absolute pressure of 5 to 150 bar, preferably 20 to 100 bar, and in the presence of a first hydrotreatment catalyst, preferably a hydrogenation catalyst, for example a hydrogenation catalyst comprising Pd (0.1-10 wt %) and/or Ni (0.1-60 wt %) and/or NiMo (0.1-60% by weight), and in a second step (d-2) in which the effluent from step (d-1) is hydrotreated at a temperature of 200 to 450 °C, preferably 250 to 340 °C, in the presence of hydrogen at an absolute pressure of 20 to 150 bar, preferably 30 to 100 bar, and in the presence of a second hydrotreatment catalyst, for example a catalyst of NiMo (0.1-60% by weight) and/or CoMo (0.1-60% by weight) type. The first step may then make it possible to hydrogenate dienes initially present in the composition.

This hydrotreatment step can be carried out in a single reactor with a plurality of catalytic beds in series, possibly with hydrogen feed between the beds, or in a plurality of reactors in series, depending on the desired objective.

This hydrotreatment step can also be used for demetallation, cracking or dearomatization according to the characteristics of the catalyst and the hydrotreatment conditions.

Preferably, the feedstock for the hydrotreatment, containing at least one portion of the purified composition, may be diluted with a portion of the hydrotreatment effluent, also having a temperature higher than the temperature desired entering the hydrotreatment, still having a temperature higher than the desired hydrotreatment inlet temperature. This at least partial recycling of the hydrotreatment effluent dilutes the unsaturates present in the purified composition and preheats the feedstock.

Preferably, the portion of the hydrotreatment effluent which is not recycled but is still at a high temperature, can exchange its sensible heat with the composition comprising a plastic liquefaction oil and thus ensure the preheating of this composition entering step b).

The effluent exiting the hydrotreatment step, namely the purified and hydrotreated composition, optionally purified by passing over a solid adsorbent, may be washed with water to eliminate inorganic compounds such as hydrosulfide, hydrogen chloride and ammonia before being subjected to subsequent treatments.

### Optional Purification Step

The second effluent from step c) or the effluent from the hydrotreatment step may be purified by passing over a solid adsorbent in order to reduce the content of at least one element from F, Cl, Br, I, O, N, S, Se, Si, P, As, Fe, Ca, Na, K, Mg and Hg and/or the water content.

The adsorbent may be operated in regenerative or non-regenerative mode, at a temperature lower than 400 °C, preferably lower than 100 °C, more preferably lower than 60 °C, selected from: (i) a silica gel, (ii) clay, (iii) crushed clay, (iv) apatite, (v) hydroxyapatite and combinations thereof (vi) an alumina for example alumina obtained by precipitating boehmite, calcined alumina such as Ceralox® from Sasol, (vii) boehmite, (viii) bayerite, (ix) hydrotalcite, (x) a spinel such as Pural® or Puralox from Sasol, (xi) promoted alumina, for example Selexsorb® from BASF, acid-promoted alumina, an alumina promoted by a zeolite and/or by a metal such as Ni, Co, Mo or a combination of at least two of them, (xii) clay treated by acid such as Tonsil® from Clariant, (xiii) a molecular sieve in the form of an aluminosilicate containing an alkali or alkaline-earth cation for example the sieves 3A, 4A, 5A, 13X, for example sold under the trade name Siliporite® from Ceca, (xiv) a zeolite, (xv) an activated carbon, or a combination of at least two adsorbents, the adsorbent or the at least two adsorbents retaining at least 20% by weight, preferably at least 50% by weight of at least one element from F, Cl, Br, I, O, N, S, Se, Si, P, As, Fe, Ca, Na, K, Mg and Hg and/or water.

According to one preferred embodiment, the adsorbent is regenerable, has a specific surface of at least 200 m²/g and is operated in a fixed bed reactor at less than 100 °C with a HVV of 0.1 at 10 h⁻¹.

### Detailed Description of the Optional Step of Separation by Distillation

The second effluent produced in step c), optionally hydrotreated, purified on an adsorbent and/or washed with water, can be separated d) by distillation into at least two separate fractions, typically a heavy fraction and a light fraction.

It is then possible to send one of these fractions to gasification stage e), advantageously a heavy fraction or the heaviest fraction is sent to gasification stage e).

This separation may in particular be carried out by distillation, in particular by atmospheric distillation or by distillation under reduced pressure.

This can make it possible to separate the second effluent into two or more fractions, the lighter fraction(s) being able, for example, to be sent to refining units of the vapor cracking or other type, and the heavy fraction(s) being sent to step e).

The second effluent produced in step c), optionally hydrotreated, purified on an adsorbent and/or washed with water, may in particular be fractionated into usable streams whose cut-off points are typically chosen according to the subsequent treatment. This fractionation can be carried out according to distillation temperature ranges, for example to separate LPG, petrol, diesel, heavy fuel oil and kerosene type streams, which can then be treated in a gasifier and/or steam cracker and/or catalytic cracker and/or hydrocracker (then possibly in a steam cracker) and/or hydrotreatment reactor and/or used as such to prepare fuels, combustibles, lubricants or base oils. A person skilled in the art knows how to select the most suitable cuts for the subsequent treatment units depending on the desired objective.

In particular, fractions 350+°C or 375+°C will advantageously be sent to gasification step e). The fractions 350+°C, respectively 375+°C correspond to fractions with an initial boiling point greater than or equal to 350 °C, respectively 375 °C.

### Detailed Description of the Gasification Step

The second effluent of step c), optionally after solid/liquid separation and/or hydrotreatment, or one of the fractions of step d), may be subjected, alone or in mixture with another hydrocarbon feedstock, to a gasification process to produce synthesis gas comprising at least dihydrogen, carbon monoxide and carbon dioxide.

The other hydrocarbon feedstock comes from crude oil treatment. This hydrocarbon feedstock generally corresponds to a 350+°C or 375+°C section. It is typically a visbroken residue, a VGO (vacuum gas oil), a residue of an atmospheric distillation, a residue of a vacuum distillation, a residue of a visbroken vacuum distillation, alone or in mixture.

Depending on the initial heteroatom contents of the plastic liquefaction oil, the second effluent of step c), optionally after solid/liquid separation and/or hydrotreatment, or one of the fractions of step d), may be subjected to the gasification step in mixture with other conventional feedstocks of petroleum origin, in particular according to the available volumes and/or so that the heteroatom content of the feedstock entering the gasification step has a heteroatom content complying with requirements. The feedstock of the gasification step may in particular contain up to 100% by mass, 90% by mass, 80% by mass, 70% by mass, 60% by mass, 50% by mass, 40% by mass, 30% by mass, 20% by mass, 15% by mass, 10% by mass or 5% by mass of the second effluent of step c), optionally after solid/liquid separation and/or hydrotreatment, or one of the fractions of step d), or within any range defined by two of these limits.

This gasification step may be a partial oxidation gasification step carried out in a partial oxidation gasification unit to produce a synthesis gas comprising at least dihydrogen, carbon monoxide and carbon dioxide.

The second effluent of step c) or one of the fractions of step d) may, prior to step e), be mixed with another hydrocarbon feedstock such as naphtha, diesel oil or any crude oil refining product to have a purified composition concentration ranging from 0.01% m to at most 90% m, preferably from 0.1% m to 75% m, even more preferably from 1% m to 50% m or within any of these limits.

In this document, the term “partial oxidation (POX) gasification unit or installation” or “POX gasification installation” means an installation which comprises all equipment, lines and controls necessary to carry out POX gasification of liquefied plastic waste. For example, the gasification installation may comprise a gasifier, a feed injector, a gasifier ball mill, a feed spray unit, and/or a solidification tank.

As used herein, the term “partial oxidation” refers to the high-temperature conversion of a feedstock containing carbon into synthesis gas (carbon monoxide, hydrogen, and carbon dioxide), where the conversion is performed with an amount of oxygen that is less than the stoichiometric amount of oxygen necessary for the complete oxidation of carbon to CO₂. Reactions that occur in a partial oxidation (POX) gasifier comprise converting a feedstock containing carbon into syngas, and specific examples of reactions comprise, but are not limited to, partial oxidation, water-gas shift-primary reactions, Boudouard oxidation reaction, methanation, hydrogen reforming, steam reforming and carbon dioxide reforming.

The present technology is generally directed to a method for producing syngas from a plastic liquefaction oil composition. The method generally comprises introducing into a POX gasifier the plastic liquefaction oil composition and an oxidizing agent comprising molecular oxygen (O₂) and performing a partial oxidation reaction in the gasifier by reacting at least part of the plastic liquefaction oil and at least part of the molecular oxygen. The plastic liquefaction oil composition may be in a solid or liquid form prior to being introduced into the POX gasifier.

The POX gasification installation comprises at least one POX gasification reactor or gasifier. In one embodiment or in combination with any of the aforementioned embodiments, the POX gasification unit may comprise a liquid-fed gasifier or a solid-fed gasifier. More specifically, in various embodiments, the POX gasification unit may perform liquid-fed POX gasification. In the present document, the term “liquid fed POX gasification” means a POX gasification process wherein the process feed comprises mainly liquid components at 25 °C and 1 atm. In addition, or alternatively, in various embodiments, the POX gasification unit may perform POX gasification in the solid state. The term “solid state POX gasification” means a POX gasification method wherein the process feed comprises mainly components that are solid at 25 °C and 1 atm. Liquid- and solid-fed POX gasification processes can be co-fed with smaller amounts of other components having a different phase at 25 °C and 1 atm. Thus, solid-feed POX gasifiers can be co-fed with liquids, but only in amounts (by mass) less than the amount of solids introduced into the solid-feed POX gasifier. In one embodiment or in combination with any of the aforementioned embodiments, the total feed of a liquid-fed POX gasifier may comprise at least 60, or at least 70, or at least 80, or at least 90, or at least 95% by mass of components that are liquid at 25 °C and 1 atm; and the total feed of a solid-fed POX gasifier may comprise at least 60, or at least 70, or at least 80, or at least 90, or at least 95% by mass of components that are solid at 25 °C and 1 atm.

In one embodiment or in combination with any embodiment mentioned herein, the oxidizing agent comprises an oxidizing gas which may include air, oxygen-enriched air, or molecular oxygen (O₂), or steam.

Partial oxidation gasification can be performed with or without a catalyst. Suitable catalysts comprise one or more metal components of groups 8 to 10 of the periodic classification, such as platinum, palladium, rhodium, iridium, osmium, ruthenium, and possibly, one or more elements of groups 5 to 7, 11, such as iron, cobalt, nickel, copper, vanadium and chromium, these elements being typically supported on a support such as zirconium, alumina, CeO₂, Y₂O₃ or TiO₂.

In one embodiment or in combination with any embodiment mentioned herein, the gasification zone, and optionally all reaction zones in the gasifier/gasification reactor, may operate at a temperature of at least 1000 °C, at least 1100 °C, at least 1200 °C, at least 1250 °C, or at least 1300 °C and/or not more than 2500 °C, no more than 2000 °C, no more than 1800 °C, or no more than 1600 °C. The reaction temperature may be autogenous. Advantageously, the steady-state gasifier can be at autogenous temperature and does not require the application of external energy sources to heat the gasification zone.

In one embodiment or in combination with any embodiment mentioned herein, the gasifier may operate at a pressure within the gasification zone (or combustion chamber) of at least 1.3 MPa to 9 MPa, examples of suitable pressure ranges comprise 2 to 7 MPa, 2 to 6 MPa, 2.5 to 7 MPa, 2 to 5.5 MPa, 3 to 5 MPa, or any range defined by any of the limits of these ranges.

In general, the average residence time of the gases in the gasification reactor can be very short to increase the throughput. Since the gasifier can operate at a high temperature and pressure, the almost complete conversion of feedstock to gas can take place in a very short time. In one embodiment or in combination with any embodiment mentioned herein, the average residence time of the gases in the gasifier may not be greater than 30, not greater than 25, not greater than 20, not greater than 15, not greater than 10, or not greater than 7 seconds.

In general, the raw syngas stream discharged from the gasification reactor comprises gases such as hydrogen, carbon monoxide and carbon dioxide and may comprise other gases such as methane, hydrogen sulfide and nitrogen depending on the fuel source and gasification conditions.

### DESCRIPTION OF THE FIGURES

FIG. 1 describes a possible embodiment of the invention. In this possible embodiment, the composition comprising a plastic liquefaction oil (1) is first pre-treated if necessary in the pretreatment section (A) in order to be subjected there to an optional pre-treatment (PTT) by (i) filtration (ii) washing with water or a polar solvent immiscible with the composition, (iii) distillation, (iv) decantation, or (v) a combination of two, three or four of steps (i) to (iv). The composition (1) or the pre-treated composition (2) is subsequently sent to a treatment section (B) in the presence of a basic compound (3) carrying out step (b) of the invention. The first effluent (4) exiting step b) and containing the modified composition may then be sent to an optional solids separation section (S1). The effluent (5) exiting the section (S1) or the first effluent (4) exiting the section (B) is then sent to a separation section (C) carrying out step c) of the present invention, consisting of the washing step (c1), the separation step (c2) or the succession of steps (c2) and (c1). When this section (C) carries out step (c2), the separated phase (7) containing the basic compound may be returned to the treatment section (B). The second effluent (6) exiting the section (C) and containing the purified composition having a reduced heteroatom content, may then be sent to an optional solids separation section (S2) or an optional hydrotreatment section (HDT) or an optional distillation section (D). Thus, the effluent (7) of the optional solids separation section (S2) or the effluent (8) of the optional hydrotreatment section (HDT) may be sent to the optional distillation section (D) to carry out step d) and be separated there into at least two fractions (9a) and (9b). One of the two fractions, preferably the heaviest fraction (9b), is then sent to the gasification unit (E) to carry out step e) and obtain a synthesis gas (10). Alternatively or in combination, the effluent (6) of the section (C), the effluent (7) of the optional solids separation section (S2) or the effluent (8) of the section (HDT) may be sent directly to the gasification section (E).

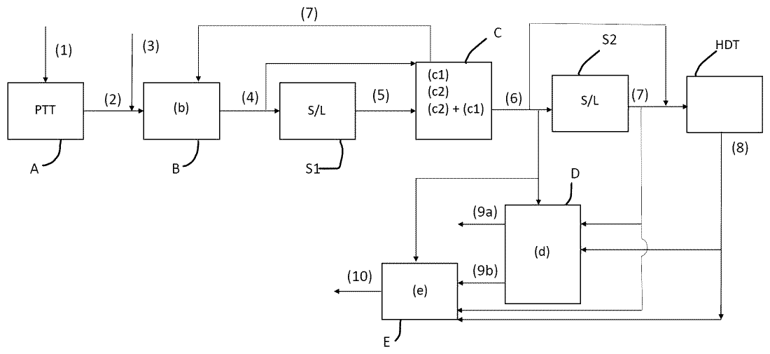

In one particularly advantageous embodiment, the installation comprises sections (B), (S1), (C), (D) and (E).

### EXAMPLES

The embodiments of the present invention are illustrated by the following non-limiting examples.

### Example 1: Purification of a Plastic Pyrolysis Oil in the Presence of a Strong Base and Water Followed by Washing with Water

The physico-chemical characteristics of the plastic pyrolysis oil used are described in Table 1 below. This product is a good representation of the overall quality of plastic pyrolysis oils, although the chlorine content is not very high.

TABLE 1

| Pyrolysis oil | HPP4 |
|---|---|
| Density (g/mL) | 0.826 |
| Kinematic viscosity (15 °C, mm²/s) | 2.78 |
| Distillation, initial boiling point (°C) | 84 |
| Distillation, 50% (°C) | 233 |
| Distillation, final boiling point (°C) | 398 |
| Silicon (ppm mass) | 45 |
| Chlorine (ppm mass) | 164 |
| Oxygen (% by mass) | 1.69 |
| Nitrogen (ppm mass) | 3510 |

### Test Protocol:

A 1.5 L AISI-316 L grade stainless steel autoclave equipped with mechanical stirring is loaded with HPP4 pyrolysis oil, a strong base in the form of NaOH and water, the strong base being solubilized in water prior to introduction into the autoclave (Table 2). The sum of the volume of pyrolysis oil and the volume of water introduced is about 600 mL at room temperature, without taking into account any effects of volume variation when mixing them. The autoclave is closed and the gas atmosphere in the autoclave is flushed with nitrogen for 30 minutes. The autoclave is then heated under autogenous pressure with stirring at a speed of 400 to 1,500 rpm at a temperature of 225 °C for 30 minutes, once the target temperature has been reached. The rate of temperature rise is fixed at 30 °C/10 minutes.

TABLE 2

| | |
|---|---|
| Test | 1 |
| Pyrolysis oil | HPP4 |
| Volume ratio water/feedstock | 0.025 |
| Temperature (°C) | 225 |
| Duration (min.) | 30 |
| Water volume (mL) | 14.5 |
| Mass of NaOH (g) | 14.5 |
| Mass of pyrolysis oil (g) | 481 |
| Initial volume of pyrolysis oil (mL) | 584 |
| NaOH concentration in pyrolysis oil (% by mass) | 3 |
| NaOH concentration in water (% by mass) | 50 |
| Initial density (g/mL) | 0.824 |
| Final pressure in the autoclave (bar) | 13 |

At the end of the reaction, the autoclave is cooled to room temperature, then the mixture is discharged and washed three times with water with, during each wash, a water/feedstock volume ratio=40/60, to remove strong base residues and water-soluble impurities. The resulting purified and washed pyrolysis oil is analyzed for residual impurity content (Table 3).

TABLE 3

| | |
|---|---|
| Test | 1 |
| Initial silicon (ppm mass) | 45 |
| Final silicon (ppm mass) | <2 |
| Silicon reduction (%) | >95 |
| Initial chlorine (ppm mass) | 164 |
| Final chlorine (ppm mass) | 16 |
| Chlorine reduction (%) | 90 |
| Initial oxygen (% mass) | 1.69 |
| Final oxygen (% mass) | 0.38 |
| Oxygen reduction (%) | 78 |
| Initial nitrogen (ppm mass) | 3510 |
| Final nitrogen (ppm mass) | 881 |
| Nitrogen reduction (%) | 75 |
| Initial sodium (ppm mass) | <2 |
| Final sodium (ppm mass) | <2 |

The data in Table 3 shows that the use of sodium hydroxide in the presence of water followed by washing significantly reduces the impurities initially contained in the pyrolysis oil as well as the sodium introduced by the sodium hydroxide treatment.

The pyrolysis oil can then either be used as is, or optionally be dried on an adsorbent such as a molecular sieve or an anhydrous salt, for example Na₂SO₄, then distilled under reduced pressure to remove any traces of solids, e.g. strong base, adsorbent residue, anhydrous/hydrated salt or gums.

### Example 2: Mixing the Product of Example 1 with a Petroleum Product

A petroleum product of the WR (Visbroken Vacuum Residue) type is considered having the following characteristics (Table 4):

TABLE 4

| Petroleum product | VVR |
|---|---|
| Density (g/mL) | 1.05 |
| Distillation curve > 550 °C (% vol) | >95% |
| Total chlorine (ppm mass) | 30 |
| Total nitrogen (ppm mass) | 8400 |
| Silicon (ppm mass) | 3 |

The mixtures below of said WR with the product of Example 1 (treated HPP4) or with the initial untreated HPP4 (HPP4) are considered, according to their silicon and chlorine levels (Table 5). The mixtures are expressed as a mass percentage of HPP4, treated or untreated. The “gasifier and downstream units specification” column corresponds to the maximum permissible values of silicon and chlorine levels in a product, before injection into a gasifier. 5

TABLE 5

| | | | VVR + | | VVR + |
|---|---|---|---|---|---|
| Contents | | VVR + | 2% | VVR + | 10% |
| (ppm | Gasification | 2% | treated | 10% | treated |
| mass) | specification | HPP4 | HPP4 | HPP4 | HPP4 |
| Si | <5 | 3.8 | 3 | 7.2 | 2.8 |
| Cl | <40 | 33 | 30 | 43 | 29 |

In this example, the treatment method according to the invention of the HPP4 oil thus makes it possible to introduce it up to 10% by mass into a mixture with the WR, while satisfying the requirements for the gasification step and its downstream units.

Depending on the heteroatom contents of the treated plastic liquefaction oil or depending on the volumes obtained, it may be considered to treat it in a gasification step alone or in mixture with other conventional feedstocks derived from petroleum.

1-12. (canceled)

13. Method for treating a composition comprising a plastic liquefaction oil by gasification, comprising the following steps:
a) providing a composition comprising a plastic liquefaction oil containing at least 20 ppm by mass of heteroatoms,
b) bringing the composition provided in step a) into contact with a basic compound at a temperature of at most 450 °C to obtain a first effluent containing a modified composition,
(c) subjecting the first effluent of step (b) to (c1) washing with water or a solvent immiscible with the modified composition, (c2) separation, or to the succession of steps (c2) and (c1), and obtaining a second effluent containing a purified composition having a reduced heteroatom content, and a phase containing the basic compound and heteroatoms initially contained in the modified composition,
d) optionally, the second effluent of step c) is separated by distillation into at least two separate fractions,
e) subjecting the second effluent of step c) or one of the fractions of step d), alone or in mixture with another hydrocarbon feedstock, to a gasification method to produce synthesis gas comprising at least dihydrogen, carbon monoxide and carbon dioxide, and wherein
prior to step b) or during step b), a basic compound previously solubilized in a polar solvent other than water immiscible with said composition is added to the composition of step a), the basic compound content of the solvent being from 15 to 50% by mass.

14. Method according to claim 13, wherein step (b) is carried out in the presence of 0.1 to 50% m of basic compound in relation to the total mass of the treated composition.

15. Method according to claim 13, wherein step (b) is characterized in that the basic compound comprises an oxide, a hydroxide, a bicarbonate, or an alcoholate of an alkali metal cation or of an alkaline-earth metal cation, or a hydroxide or a bicarbonate of a quaternary ammonium cation, alone or in a mixture.

16. Method according to claim 13, wherein step b) is characterized in that the basic compound is selected from LiOH, NaOH, CsOH, Ba(OH)₂, Na₂O, KOH, K₂O, CaO, Ca(OH)₂, MgO, Mg(OH)₂, NH₄OH, TMAOH, TEAOH, TBuOH, MeONA, EtONa and the mixtures thereof.

17. Method according to claim 13, characterized in that step (b) comprises one or more of the following features:
step b) is carried out at a temperature of 50 to 450 °C, preferably 50 to 350 °C, more preferably 50 to 250 °C, more preferably still 50 to 225 °C, 50 to 200 °C, 70 to 190 °C or 80 to 185 °C,
step b) is performed for a duration of 0.1 second to 3 hours, preferably 0.1 second to 2 hours, more preferably 1 minute to 1 hour, 1 minute to 20 minutes or 1 minute to 16 minutes.

18. Method according to claim 13, wherein, prior to the treatment of step (b), said composition provided by step a) is subjected to (i) a filtration, (ii) washing with water or a polar solvent immiscible with the composition, (iii) a distillation, (iv) a decantation, or (v) to a combination of two, three or four of steps (i) to (iv).

19. Method according to claim 13, characterized in that step (c) is preceded or followed by a step of separating solids by (i) filtration, (ii) centrifugation, (iii) hydroclone or (iv) a combination of two or three of these steps.

20. Method according to claim 13, characterized in that step c) is followed, optionally before the optional step d) of separation, by one or more of the following treatments (i) a purification treatment by passing over a solid adsorbent in order to decrease the content of at least one element out of F, Cl, Br, I, O, N, S, Se, Si, P, As, Fe, Ca, Na, K, Mg and Hg and/or water content, (ii) one or two-step catalytic hydrotreatment to provide a hydrotreated purified composition.

21. Method according to claim 13, characterized in that step (c) comprises at least the separation step (c2) for separating the phase containing the basic compound and heteroatoms, and the purified composition, and in that the phase containing the basic compound and heteroatoms is returned in whole or in part to step (b).

22. Method according to claim 13, characterized in that step c1) is performed in the presence of water with a neutral, basic or acid pH.

23. Method according to claim 13, characterized in that step c2) is carried out by (i) centrifugation, (ii) decantation, (iii) hydrocyclone or (iv) by a combination of two or three of these steps.

24. Method according to claim 13, wherein the synthesis gas produced in step e) is (i) treated in a purification unit, (ii) treated in a Fischer-Tropsch method, (iii) used as fuel, and/or (iv) used in an alcohol production unit by fermentation or catalytic means.

25. Method according to claim 13, wherein the immiscible polar solvent is selected from (i) sulfur compounds, for example dimethyl sulfoxide, (ii) nitrogen compounds, for example N,N-dimethylformamide, (iii) halogen compounds, for example dichloromethane or chloroform, (iv) ethylene glycol, or:
glycol ethers, including in particular polyethylene glycol of chemical formula HO—(CH2-CH2-O)n-H with a weight-average molar mass of 90 to 800 g/mol, for example diethylene glycol and tetraethylene glycol, polypropylene glycol of chemical formula H[OCH(CH3)CH2]nOH with a weight-average molar mass of 130 to 800 g/mol, for example dipropylene glycol and tetrapropylene glycol,
dialkyl formamides, wherein the alkyl group may comprise 1 to 8 or 1 to 3 carbon atoms, particularly dimethyl formamide (DMF),
dialkyl sulfoxides, wherein the alkyl group may comprise 1 to 8 or 1 to 3 carbon atoms, particularly dimethyl sulfoxide (DMSO) and sulfolane,
compounds comprising a furan ring,
cyclic carbonate esters, particularly comprising 3 to 8 or 3 to 4 carbon atoms, particularly propylene carbonate and ethylene carbonate.

26. Method of claim 13, wherein the immiscible polar solvent is ethylene glycol or a glycol ether, or a compound comprising a furan ring, or a cyclic carbonate ester, alone or in mixture, preferably alone.
